(19) United States
(12) Patent Application Publication
(10) Pub. No.: US 2025/0332990 A1
(43) Pub. Date: Oct. 30, 2025

(54) TRAILER HITCH PROJECTOR

(71) Applicant: David Gulotta, New Iberia, LA (US)

(72) Inventor: David Gulotta, New Iberia, LA (US)

(21) Appl. No.: 19/072,202

(22) Filed: Mar. 6, 2025

Related U.S. Application Data
(60) Provisional application No. 63/562,042, filed on Mar. 6, 2024.

(51) Int. Cl. B60Q 1/26; B60Q 1/00; B60Q 1/44

(52) U.S. Cl. CPC B60Q 1/2661; B60Q 1/0088; B60Q 1/44; B60Q 2400/50

(57) ABSTRACT

A trailer hitch projector and lighting device comprises a housing, a circuit board disposed within the housing and a projector element disposed within the housing. The projector element comprises a lens, a brake light disposed within said housing, and an attachment means. The projector and lighting device is operable to be mounted in and attached to the trailer hitch of a vehicle and connected to the trailer light electrical outlet. The trailer hitch projector displays an image on the ground underneath the vehicle allowing for consumer vehicle personalization and provides the benefit of increased vehicle under-carriage lighting.

### CROSS-REFERENCE TO RELATED APPLICATIONS

This invention relates to an accessory for the customization of a vehicle.

### FIELD OF INVENTION

This application claims priority to U.S. Provisional Patent Application Ser. No. 63/562,042, filed Mar. 6, 2024, the entirety of which is incorporated by reference as if fully disclosed herein.

### BACKGROUND

The world of vehicle customization has grown to nearly every component of cars and trucks, including custom colors, rims, mufflers, spoilers, tinted windows, interior upholstery, steering wheel covers and of course, fuzzy dice on the rearview mirror. People love to personalize their vehicles. Unique external vehicle lighting, such as puddle lighting, is an area of vehicle customization that has not escaped the explosion in market options. External vehicle lighting, however, can require more expertise to install than other vehicle accessories because of the need to properly secure the devices and the difficulty in connecting the lighting to a power source. Further, many lighting systems only display a colored light and do not allow for the full potential of such systems, such as the display images or videos. Therefore, a market need exists for easy to install lighting capable image or video accessories that allow for the imagination of consumers to be fully realized.

### BRIEF SUMMARY OF THE INVENTION

In accordance with embodiments of the invention, a trailer hitch projector is provided. The present invention is a projector and lighting device that is mounted in and attached to the trailer hitch of a vehicle and connected to the trailer light electrical outlet. The trailer hitch projector displays an image on the ground underneath the vehicle allowing for consumer vehicle personalization and provides the benefit of increased vehicle under-carriage lighting. This increased lighting allows drivers following the user of the trailer hitch projector to better see debris and/or hazards coming from underneath the vehicle of the trailer hitch projector user and allows a greater window of anticipation and reaction for the following drivers in lowlight environments. This creates a generally safer driving environment for all on the road.

### BRIEF DESCRIPTION OF THE DRAWINGS

The foregoing and other objects, features, and advantages of the invention are apparent from the following detailed description taken in conjunction with the accompanying drawings in which like parts are given like reference numerals and, wherein:

FIG. 1 is an isometric view of a trailer hitch projector showing the bottom and vehicle facing sides in accordance with embodiments of the invention.

FIG. 2 is an isometric view of a trailer hitch projector showing the bottom and rear facing sides in accordance with embodiments of the invention.

FIG. 3 is a view of a trailer hitch projector showing the contents of the box-like housing in accordance with embodiments of the invention.

FIG. 4 is a view of the bottom of a trailer hitch projector with the projecting element pulled away from the housing exposing circuity in accordance with embodiments of the invention.

FIG. 5 is a view of the circuit board of a trailer hitch projector in accordance with embodiments of the invention.

FIG. 6 is a view of the back of the circuit board and connecting circuitry in of a trailer hitch projector accordance with embodiments of the invention.

FIG. 7 is a view of a trailer hitch projector when it is installed in the trailer hitch of a vehicle in accordance with embodiments of the invention.

FIG. 8 is a view of a trailer hitch projector when it is installed in the trailer hitch projecting an image onto the ground and isometric view of the trailer hitch projector in accordance with embodiments of the invention.

FIG. 9 is a view of the rearward facing surface of a trailer hitch projector and the bottom of the trailer hitch projector showing the exposed portion of the projecting element in accordance with embodiments of the invention.

FIG. 10 is a view of the attachment portion and power plug of the trailer hitch projector in accordance with embodiments of the invention.

FIG. 11 is a view of a trailer hitch projector when it is installed in the trailer hitch of a vehicle and displaying an image in accordance with embodiments of the invention.

The images in the drawings are simplified for illustrative purposes and are not depicted to scale. Within the descriptions of the figures, similar elements are provided similar names and reference numerals as those of the previous figure(s). The specific numerals assigned to the elements are provided solely to aid in the description and are not meant to imply any limitations (structural or functional) on the invention.

The appended drawings illustrate exemplary configurations of the invention and, as such, should not be considered as limiting the scope of the invention that may admit to other equally effective configurations. It is contemplated that features of one configuration may be beneficially incorporated in other configurations without further recitation.

### DETAILED DESCRIPTION

The following description sets forth numerous specific rules, parameters, and the like. It should be recognized, however, that such description is not intended as a limitation on the scope of the present invention but is instead provided as a description of exemplary embodiments. Various modifications to the examples described will be readily apparent to those of ordinary skill in the art, and the general principles defined may be applied to other examples and applications without departing from the spirit and scope of the invention. Thus, the present invention is not intended to be limited to the examples described herein but is to be accorded a scope consistent with the claims.

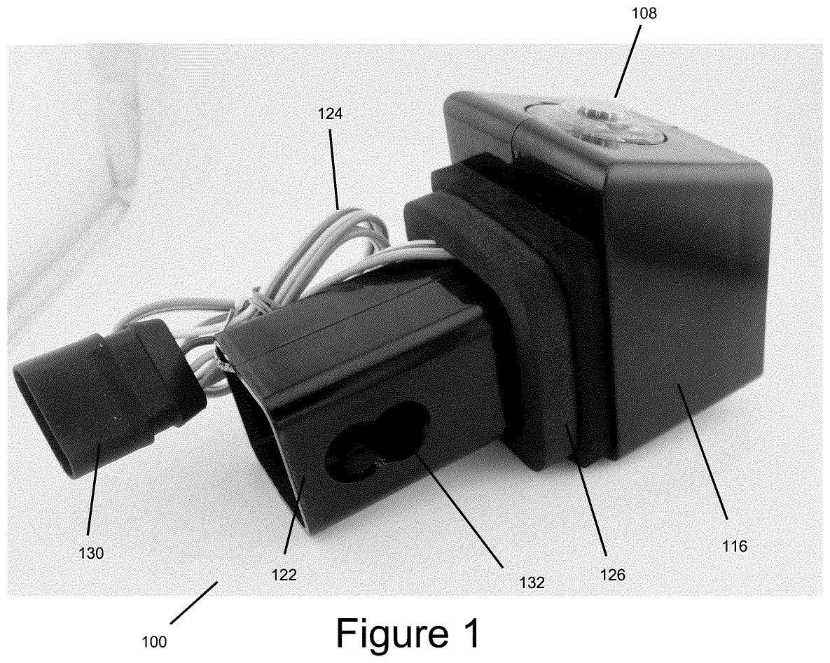

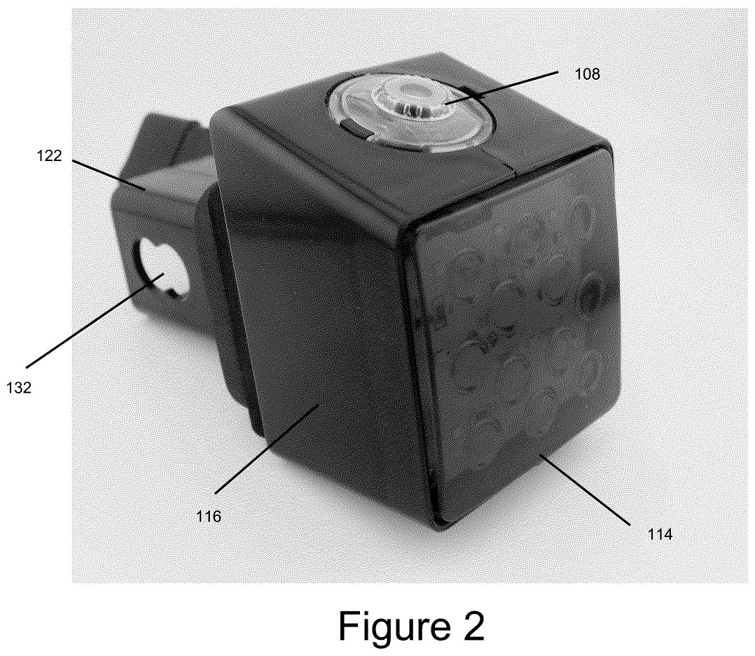

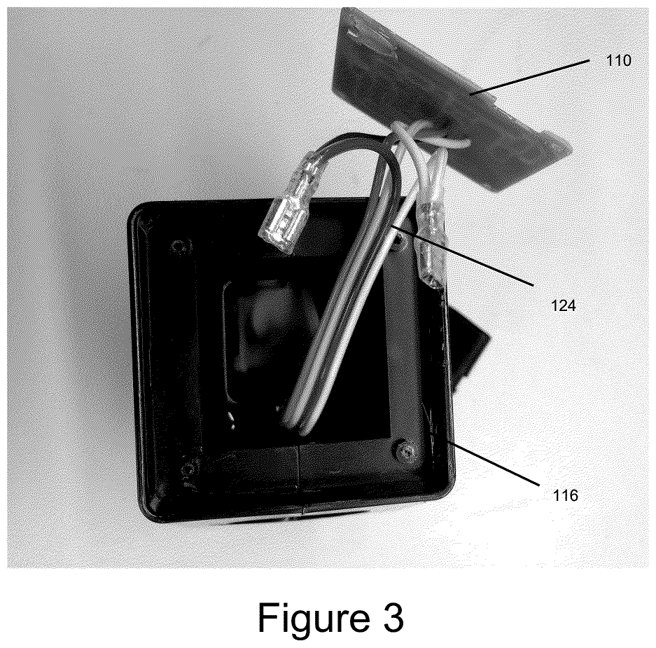

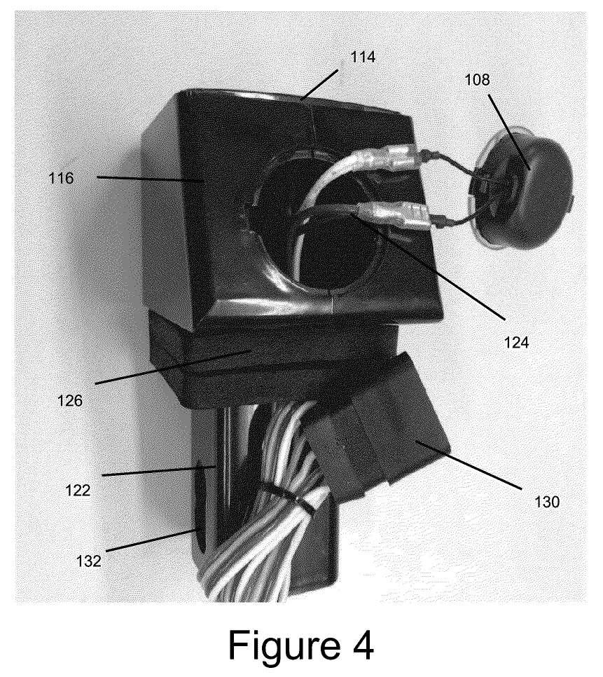

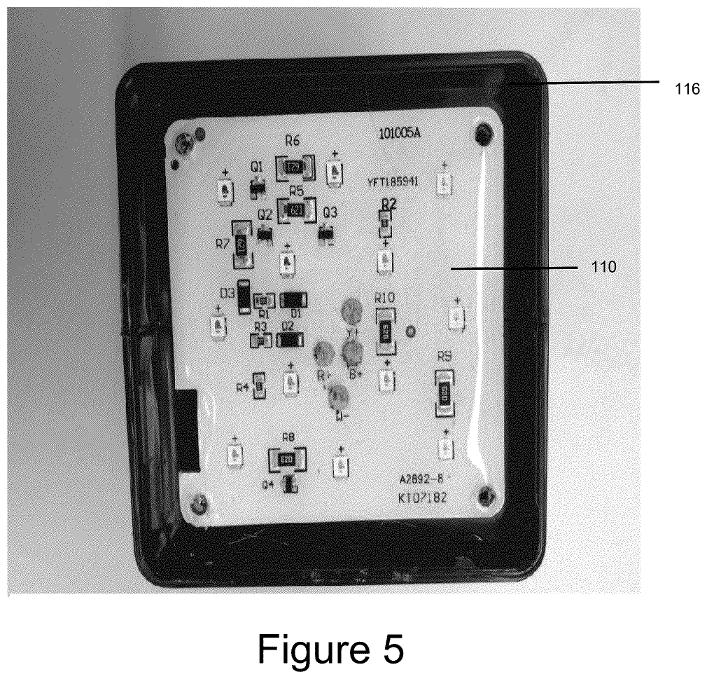

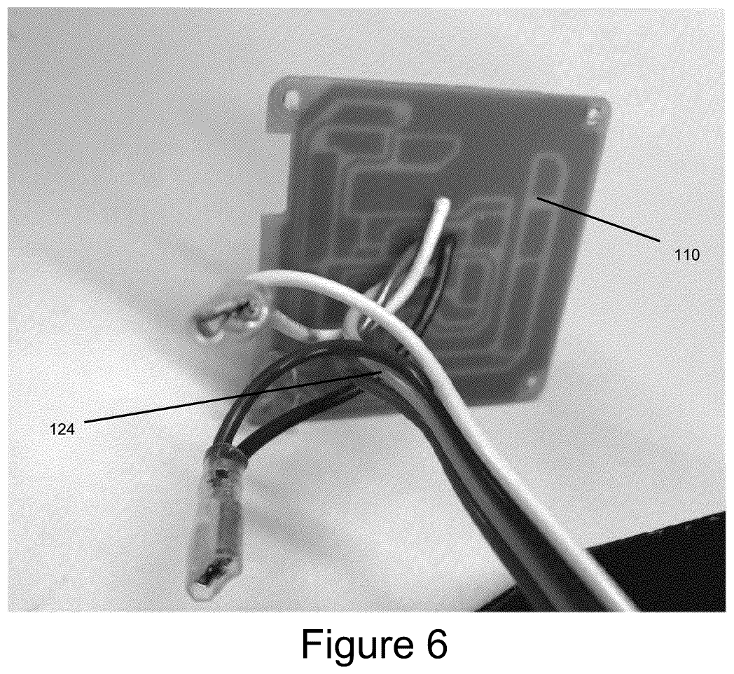

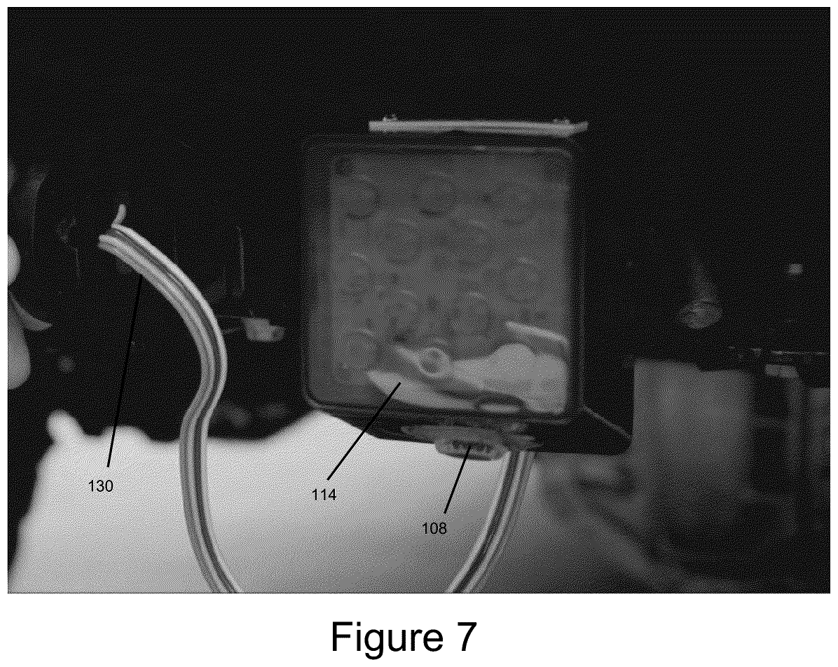

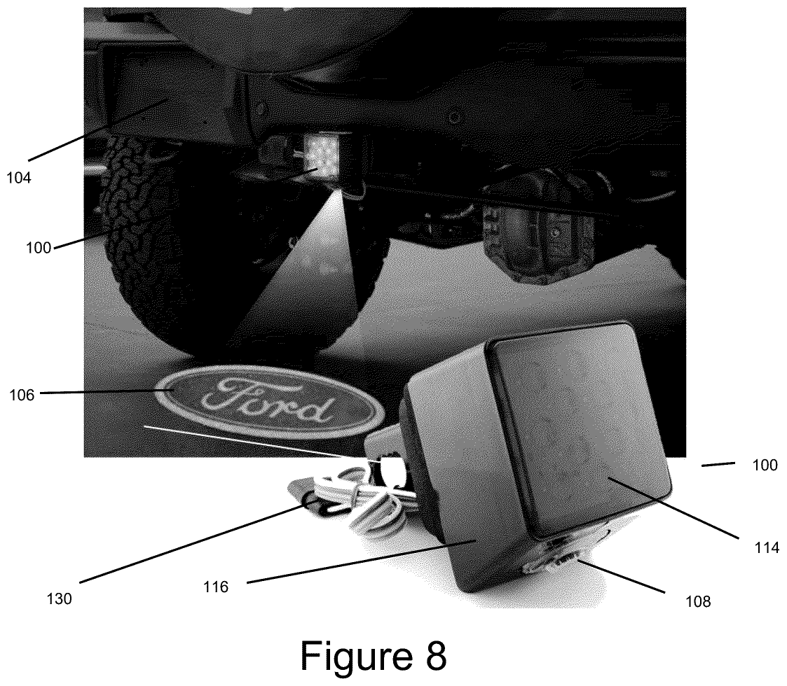

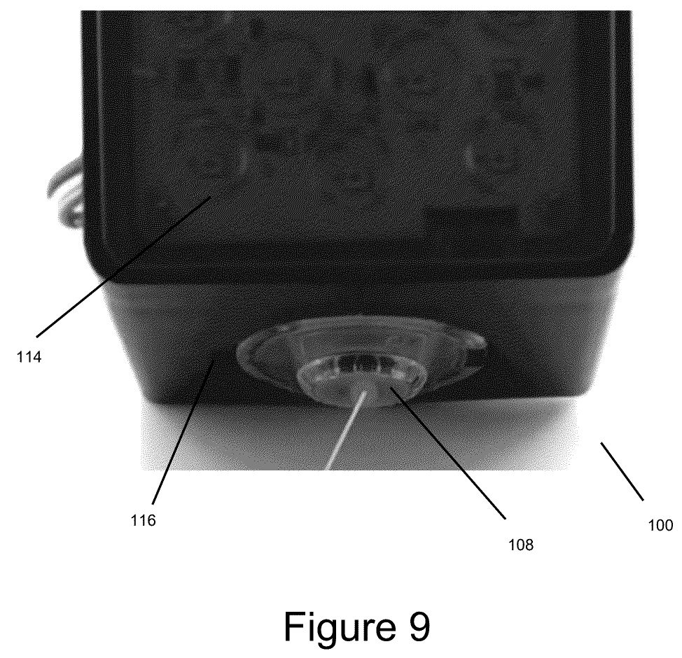

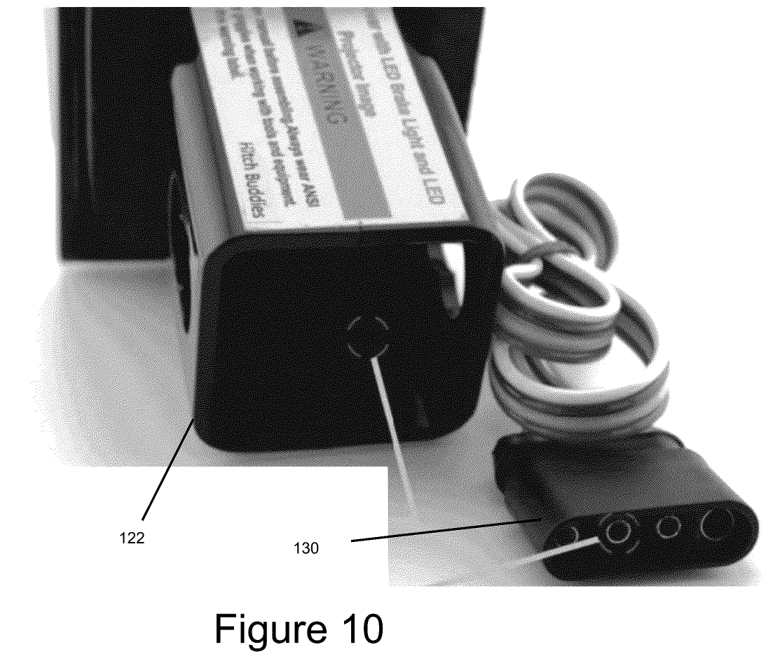

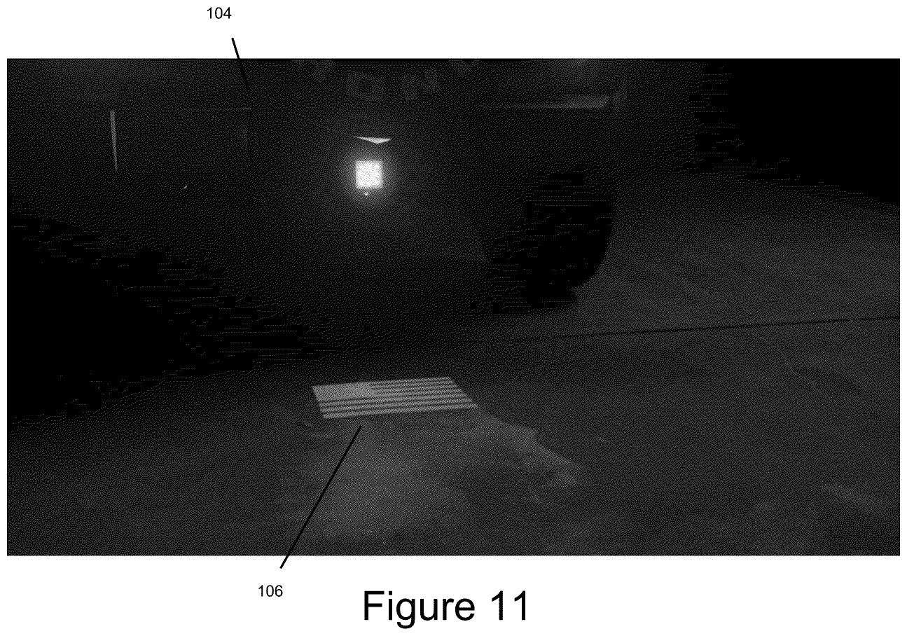

In accordance with embodiments of the invention, a trailer hitch projector 100 is provided, as illustrated in FIGS. 1-11. The trailer hitch projector 100 is operable for attachment to a trailer hitch 102 of a vehicle 104 to project an image or video 106 onto the ground beneath a vehicle. The trailer hitch projector 100 is a projector and lighting system that is operable to be attached to the trailer hitch 102 of a vehicle. The trailer hitch projector 100 incorporates a projector element 108 in communication with either a circuit board or processing unit 110 for storage of the image(s) and/or videos to be displayed. The projector element 108 and one of a circuit board or microprocessor 110 are in communication with a power supply 112. The trailer hitch projector device 100 also incorporates a rearward-facing brake light 114.

The trailer hitch projector 100 includes housing 116 wherein the lens portion of projector element 108 is on the bottom face of the box-like housing such that it faces the ground when installed in the trailer hitch receiver tube 120 of a vehicle 104. The trailer hitch projector 100 further comprises an attachment portion 122 extending from the box-like housing toward the vehicle when the trailer hitch projector 100 is installed or in the proper orientation to be installed. In some embodiments, the attachment portion 122 is configured to be received in the receiver tube 120 of the trailer hitch 102. The power supply 112 includes a power plug 130 that extends from the face of box-like housing that faces the vehicle when the trailer hitch projector 100 is installed. In some embodiments, the trailer hitch projector 100 comprises a brake light which is located on the side of the box-like body that faces away from the vehicle when the trailer hitch projector 100 is installed. The housing 116 includes at least the circuit board and/or microprocessor 110, circuitry 124, the projecting element 108 and the base of the attachment means 126.

The power plug 130 is configured to interface with a power supply socket 128 available for trailer lights located on or near the trailer hitch of the vehicle. The trailer hitch projector 100 can have any standard plug configuration used for vehicle trailer power supplies, for example a 4-way flat wire connector. The power plug 112 may be made to be compatible with a converter adapter. The projecting element 108 and circuit board or microprocessor 110 are configured to be compatible with any standard trailer light power supply, for example, 12V outlets.

The projecting element 108 can be any form of projector, for example, an LED projector. The projecting element 108 is in communication with the power circuity 124 and circuit board or microprocessor 110. In one embodiment, the projecting element 108 is configured to only activate when the headlights of the vehicle are on.

The trailer hitch projector 100 may incorporate a rearward facing brake light 114. The brake light 114 provides an additional safety measure for the vehicle by making a vehicle more visible when braking by producing more light and by adding another backup light in the instance that other brake lights are inoperable. The brake light 114 can be configured to be always on, or activated only when the vehicle's brake is depressed. The brake light 114 is powered by the same power system 112 as the projecting element 108.

The trailer hitch projector 100 may incorporate any means suitable to attach the trailer hitch projector 100 to the trailer hitch of a vehicle 102. In one embodiment, the trailer hitch projector 100 includes a hollow column sized to fit around the outside of a trailer hitch (not shown). In one embodiment, the attachment means is a hollow column 122 capable of being received in the receiver tube trailer hitch of a vehicle 102. The hollow column 122 may be any shape that allows the trailer hitch projector 100 to fit on or in the receiver tube of the trailer hitch, for example, generally rectangular to match the shape of a vehicle's receiver tube, generally circular, ellipsoid, triangular, etc. The hollow column 122 can be sized to fit in any standard trailer hitch receiver tube, for example, a 2-inch opening. The hollow column 122 may further comprise one or more apertures 132 for receiving a hitch pin or any other form of pin, dowel or clip 134.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the system (and components of the individual operating components of the system) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

1. A trailer hitch projector, comprising:
a housing;
a circuit board disposed within said housing;
a projector element disposed within said housing, said projector element comprising a lens;
a brake light disposed within said housing; and
an attachment means.
